(19) United States
(12) Patent Application Publication
(10) Pub. No.: US 2020/0214428 A1
(43) Pub. Date: Jul. 9, 2020

(54) Method and System for Guiding a User to Use an Applicator

(71) Applicant: The Procter & Gamble Company, Cincinnati, OH (US)

(72) Inventors: Shunhsiung SHIH, Singapore (SG); Xiao Fang ANG, Singapore (SG)

(21) Appl. No.: 16/721,001

(22) Filed: Dec. 19, 2019

Related U.S. Application Data
(60) Provisional application No. 62/788,193, filed on Jan. 4, 2019.

(51) Int. Cl. A45D 44/00; G06K 9/00; G06T 7/73; G06T 19/00

(52) U.S. Cl. CPC A45D 44/005; G06K 9/00281; G06K 9/00671; G06T 2200/24; G06T 19/006; A45D 2044/007; G06T 7/74

(57) ABSTRACT

Disclosed is a method and system for guiding users to use an applicator such as applicators for facial skin, the method and the system including: a step/unit of displaying an application surface and a graphic to point out the target area, to a user in real-time; a step/unit of detecting the location of an applicator, to confirm alignment of the applicator to the target area; a step/unit of detecting the action of the applicator on the target area; and a step/unit of notifying a progress and/or a completion of the applicator action, for example, by the color change of the graphic to point out the target area. The method and system improve user's compliance with use instruction, and/or efficacy of the applicator.

### FIELD OF THE INVENTION

Systems and methods for guiding a user to use an applicator, including the applicator used for a user's face and skin.

### BACKGROUND OF THE INVENTION

Often, applicators are not familiar to the consumer and have unique instructions to get the best or advertised results, which, if not followed or only partially followed (i.e. “noncompliance”), can lead to undesired results. For example, under or over use of the applicator, misapplication of the applicator in terms of location, applicator action, and/or application time, and/or confusion as to the correct way to use the applicator can lead the consumer to become frustrated, confused and/or unhappy with the applicator. It can also lead to reduced efficacy of the applicator and/or performance that is not consistent with the advertised or indicated benefits or results.

Many different methods and technologies have been used in an attempt to improve user's compliance with use instruction, and/or to improve the efficacy of the applicator, and if used together, the efficacy of the applied consumer products as well. However, such methods and technologies often fail or are not consumer desired for one or more of the following reasons: the consumer is unwilling to spend the time needed to read lengthy instructions; the consumer does not want to travel to get help; the consumer does not want to ask another human for help; the directions for use are not easy to put into practice based on the instructions given; the instructions are so generic to the potential population of users that they are difficult for the consumer to replicate on him or herself; or the consumer can't remember the appropriate steps to ensure proper application of the product. Although the use of printed, life-like graphics and/or video tutorials can help, they still often fail to provide the needed information to the consumer at the right time and in a way that the consumer can quickly understand, execute and remember the proper techniques for effective use and/or customized use of the applicator.

Therefore, it would be desirable to provide users with an intuitive, customized system and/or method for improving a user's understanding of the intended use of an applicator and/or how the applicator is effectively used.

### SUMMARY OF THE INVENTION

The present invention is directed to a method for guiding users to use an applicator; the method including the steps of:

(a) a detecting an application surface;

(b) a detecting a target area in the application surface;

(c) a creating a graphic to point out the target area;

(d) a displaying the application surface and the graphic to point out the target area, to a user in real-time;

(e) a detecting location of an applicator;

(f) a detecting the action of the applicator on the target area; and

(g) a notifying a progress and/or a completion of the applicator action.

The present invention is also directed to a system for guiding a user to use an applicator; the system comprising:

(a) a unit to detect an application surface;

(b) a unit to detect a target area in the application surface, connecting to the following unit;

(c) a unit to create a graphic to point out the target area;

(d) a unit to display the application surface and the graphic to point out the target area, to a user in real-time, connecting to the application surface detecting unit at least;

(e) a unit to detect a location of an applicator, connecting to the following unit;

(f) a unit to detect the action of the applicator on the target area, connecting to the following unit; and

(g) a unit to notify a progress and/or a completion of the applicator action.

The present invention combines the use of augmented reality and recognition technology to create real-time application tutorials that are intuitive and effective. This unique combination has been shown to provide a surprising and unexpected benefit over prior systems and methods.

For example, it has been surprisingly found that consumer compliance with respect to application and use instructions for applicators, can be improved significantly using the system and method of the present invention. It has been unexpectedly found that, for applicators especially those applied to facial skin surface, the use of real-time, augmented reality to display the target surface onto which the applicator is to be applied along with notifying the progress and/or completion of the applicator action will result in significantly improved user compliance, satisfaction with the applicator, and/or improved efficacy of the applicator as compared to prior systems and methods.

The method and the system of the present invention provides an intuitive, customized system and/or method:

for improving user's understanding of the intended use of an applicator and/or how the applicator is effectively used, and/or for improving user's compliance with use instruction; and/or

for improving efficacy of the applicator, by improved accuracy of the applicator action to the target area, for example, by better alignment of the applicator to the target area, and/or more adequate duration, intensity, and/or type of applicator action.

### BRIEF DESCRIPTION OF THE DRAWINGS

FIGS. 1A-1I are a simplified flow chart of an example of the method and system of the present invention.

FIGS. 2A-2D depict exemplary graphic images showing how certain steps of the method of the present invention may be displayed to the user.

### DETAILED DESCRIPTION OF THE INVENTION

While the specification concludes with claims which particularly point out and distinctly claim the invention, it is believed the present invention will be better understood from the following description.

The present invention may comprise the elements and limitations described herein, as well any of the additional or optional steps/units, components, or limitations suitable for use with the invention, whether specifically described herein or otherwise known to those of skill in the art.

As used herein, the term “augmented reality” or “AR” refers to technology that superimposes a computer-generated image on a user's view of the real world, thus providing a composite view of the real world and a computer-generated graphic.

As used herein, the term “compliance” refers to the situation where a user of an applicator closely follows the directions for using the applicator, with or without consumer product.

As used herein, the term “noncompliance” refers to the situation where a user of an applicator does not follow one or more of the usage or application instructions of the applicator.

As used herein, the term “real-time” refers to the actual current time that an event is happening plus a small amount of additional time required to input and process data from the event and to provide feedback to a user. For example, a real-time image of a user may be displayed on a screen of a device such as a computer or mobile computer such as a mobile phone or mobile tablet computer at the same time the user is inputting the image information via, for example, the device's camera, plus the few milliseconds it may take for the device to process the image and display it on the device's screen.

As used herein, the term “applicator” refers an applicator to any surface, used with or without consumer products. Although not limited thereto, one type of applicators that is especially benefitted by the system and method of the present invention is an applicator to be applied to surfaces of the body, for example, a skin including facial skin and body skin, hair, teeth and/or nails, preferably a facial skin. Such applicators are used for, for example, hair care, body care, facial skin care, shave care, and/or oral care. Such applicators can be used with or without consumer products to be applied to such surfaces of the body. Non-limiting examples of such consumer products are, for example, personal care products such as hair care, body care, facial skin care, shave care, health care and/or oral care products.

Examples of systems and methods in accordance with the present invention are described hereinbelow. Although the examples are specifically directed to those using an applicator used for facial skin, the invention is not limited to such applicators and should be understood to relate to any and all applicators unless expressly described herein as limited to that particular embodiment.

The system and method of the present invention are described herein having certain input and output devices, and an applicator device. It should be understood that such input and output devices are only examples of devices that can be used to carry out the method. It is fully contemplated that other suitable input and output devices can be used with the methods and systems of the present invention and the disclosure herein should not be considered to be limiting in terms of any such devices. In addition, as described herein, the method and/or system of the invention may include or involve certain software and executable instructions for computing devices. As with the input and output devices for the present invention, the disclosure of any specific software or computer instructions should not be limiting in terms of the specific language or format as it is fully expected that different software and computer instructions can lead to the same or significantly the same results. As such, the invention should be considered to encompass all suitable software, code and computer executable instructions that enable the devices used in the methods and processes to provide the necessary inputs, calculation, transformations and outputs. Finally, the specific graphics shown in the figures and described herein are merely examples of graphics that are suitable for the methods and processes of the claimed invention. It is fully contemplated that specific graphics for any particular use will be created, chosen and/or customized for the desired use.

In the present invention, some or all of the steps of the method can be done by one device or can be done by two or more devices, other than an applicator. Similarly, some or all of the units of the system can be located in one device or can be located separately other than an applicator, while having necessary connections. Also, some units can be consolidated into one unit. In the present invention, it is preferred to use one applicator and one device.

Such devices used herein are, for example: a computer; a mobile computer such as a mobile phone or mobile tablet computer; or any other devices with at least one of the followings and a connection with other devices for missing function; a camera; means for displaying; and means for communication/connection with the applicator.

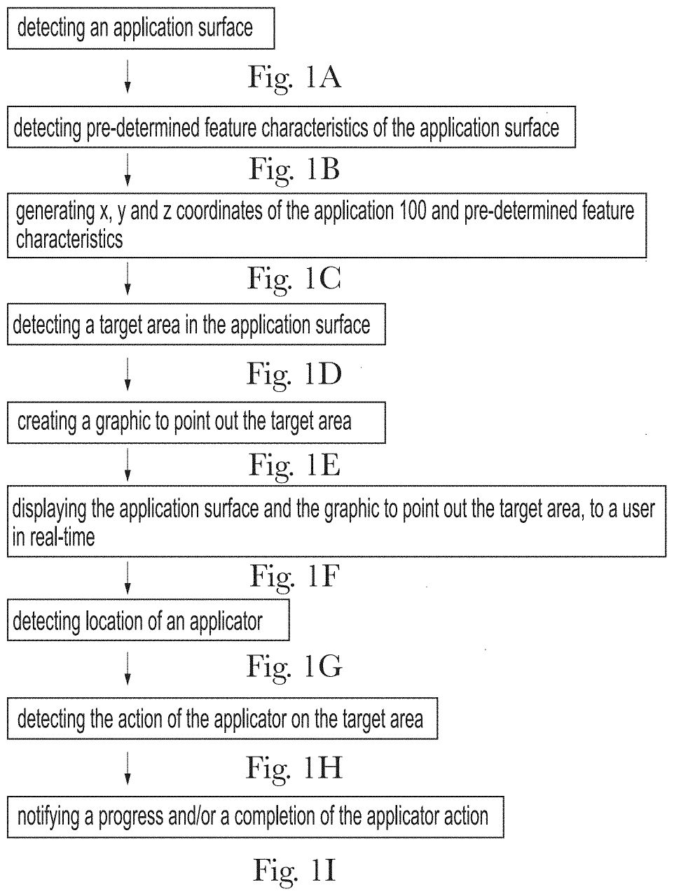

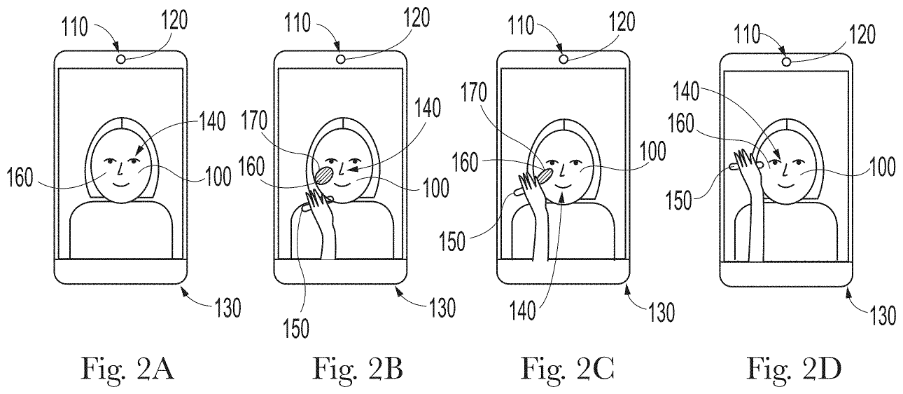

FIGS. 1A-1I form a simplified flowchart of a system and method of the present invention. Specifically, the flowchart shows the steps/units included in the method/system of improving compliance with use instructions for a skin care applicator, such as a facial skin care applicator. The steps/units shown are intended to illustrate the general flow of the steps/units of the method/system. However, the order of the steps/units is not critical, and it should be understood that additional steps/units can be included in the method/system before, between or after any of the steps/units shown. Additionally, the steps/units shown in FIGS. 1A-1I are exemplary in that some or all may be used in embodiments of the present invention, but there is no requirement that any or all of the specific steps/units shown are required in all embodiments and it is contemplated that some of the steps/units can be combined, separated into more than one step/unit and/or changed and still be considered within the present invention. The description of the steps/units represented by FIGS. 1A-1I refers to features that, for reference purposes, are illustrated and called out numerically in FIGS. 2A-D.

FIG. 1A represents the step/unit of detecting an application surface. An “application surface” as used herein refers to a surface or a portion of a surface to which an applicator will be applied. For example, as shown in FIG. 2A, the application surface 100 may be a portion of a user's skin, such as a face, portion of a face, or other part of the body. The application surface 100 is detected by an image input device 110 (so called as “application surface detecting unit” in the system), such as, for example a camera 120 shown in FIGS. 2A-2D. The image input device 110 detects a real-time image of the application surface 100, such as the user's face, connecting to a computing device 130, such mobile phone for additional processing. The computing device 130 includes or is capable of executing software, code or other instructions to allow it to detect, display and/or transform the image. In the system of the present invention, this unit can connect directly or indirectly to, at least, a unit to display the application surface.

FIG. 1B represents an optional step/unit of detecting one or more pre-determined feature characteristics 140 of the application surface 100. For example, the computing device 130 may detect the lips, nose, eyes and eye brows of the user if the application surface 100 is the user's face. This step/unit allows the computing device 130 to determine the location of the application surface 100 and the relative location of the different pre-determined features 140 that can be used to “track” the features and/or locate how and/or where output graphics may be displayed. In the system of the present invention, this unit can connect directly or indirectly to, at least, a unit to display the application surface.

FIG. 1C represents an optional step/unit of generating x, y and z coordinates of the application surface 100 and any pre-determined feature characteristics 140. This step/unit, allows the computing device 130 to determine the relative location of the different pre-determined features 140 and can be used to “track” application surface 100 and/or the pre-determined features to locate how and/or where output graphics should be displayed. In the system of the present invention, this unit can connect directly or indirectly to, at least, a unit to display the application surface.

FIG. 1D represents a step/unit of detecting a target area in the application surface. The target area is preferably a facial skin, more preferably is a specific area of a facial skin which is assessed to need the applicator action. When the target area is a specific area of a facial skin, such target area typically has one of the following conditions, for example, wrinkle, blemish, fine line, pore, spots, dullness, and/or dry flakes. In the system of the present invention, this unit can connect directly or indirectly to, at least, a unit to display the application surface and/or a unit to create a graphic to point out the target area.

FIG. 1E represents a step/unit of creating a graphic to point out the target area. Graphics are, for example: colored graphics on the target area; and/or a pointer to point out the target area with an indication showing outside of the target area or even outside of the application surface. Creation of the graphic can contain a creation of one or more type of graphics wherein each of the one or more type of graphics are for one or more conditions of the target area. In the system of the present invention, this unit can connect directly or indirectly to, at least, a unit to display the application surface and the graphic to point out the target area.

Optionally, together with the above graphic, a condition of the target area can be displayed. The method/system of the present invention optionally contains a step/unit to display such a condition of the target area. The display of the condition of the target area include, at least one of the followings: indication of a level of a certain condition; indication of a specific type of condition. The indication of the type of the condition can be expressed by a certain color of the graphics (for example, red for wrinkle, and yellow for blemish), description (such as wrinkle, blemish) on the graphics or description pointing out the graphics from outside of the graphics. The indication of the level of the condition can be expressed by, for example, a color intensity of the graphics (for example, deep red for serious wrinkle, middle red for conventional wrinkle, light red for slight wrinkle), a number of stars, score bar, description on the graphics or description pointing out the graphics from outside of the graphics. In the system of the present invention, this unit can connect directly or indirectly to, at least, a unit to display the application surface and the graphic to point out the target area and/or a unit of detecting a target area.

FIG. 1F represents a step/unit of displaying the application surface and the graphic to point out the target area, to a user in real-time. FIG. 2A show examples of application surface 100 displayed on a mobile device. The method and system of the present invention will display the application surface 100 in real-time, and the application surface 100 will be continuously, or nearly continuously displayed throughout the applicator action. The method and system of the present invention will also display the graphics 170 to point out the target area 160. Alignment of the graphic 170 and the target area 160 in real-time, and notification of the progress and completion of the applicator action provides the user with an augmented reality experience that, for example, the user visually understand that they use the applicator in a right way such as right location of the applicator and right duration of applicator action and/or the user visually perceive the effect of the applicator. For especially effective augmented reality, the graphic 170 to point out the target area should be able to track with the target area even if it moves during the applicator action.

Those shown in FIGS. 2A-D are representative of those that may be displayed on a mobile device such as a mobile phone or tablet computer. Such mobile device can be replaced with any one or more suitable displays or in any suitable way that is viewable by the user, including, but not limited to monitors, mobile computing devices, television screens, projected images, holographic images, mirrors, smart mirrors, any other display devices of any suitable size for the desire use, and combinations thereof.

The target area 160 is that portion of the application surface 100 to which an applicator is to be applied. For example, as shown in FIGS. 2A-2D, the target area 160 is the cheek portion of the user's face. Graphics 170 to point out the target area are shown in FIGS. 2B and 2C.

FIG. 1G represents a step/unit of detecting location of an applicator 150. This could be for confirming alignment of the applicator 150 to the target area 160, for guiding the user on where to position the applicator and/or any other purposes. The location of the applicator can be detected by any means, for example, using gyroscope in the applicator, image analysis based on pre-determined/pre-recorded applicator shape and/or a marker on the applicator and machine learning. Optionally, this step/unit or another step/unit can display the applicator 150 in real-time, as shown in FIG. 2B-2D. When the target area is a specific area of a facial skin, the applicator can be typically selected based on at least one of the following purpose and/or mechanism: consumer product application, including but not limited to, facial mask and/or eye mask-type applicator; consumer product spreading; massaging; dermabrasion; ultrasound; heat; cool; light; UV; laser; infra-red; epilation; exfoliation; hair removal; and vibration. In the system of the present invention, this unit can connect directly or indirectly to, at least, a unit to detect the action of the applicator on the target area.

FIG. 1H represents a step/unit of detecting the action of the applicator 150 on the target area 160. The applicator action discussed herein is a pre-determined action that the user should follow to properly apply the applicator to the target area 160. The applicator action will typically be pre-programmed and available to and/or stored in the computing device 130 prior to starting the method. However, it is contemplated that the applicator action could be generated in real-time by the computing device 130 and/or provided to the computing device 130 before or as the action is being performed. Additionally, the computing device 130 may include or obtain two or more different application action that can be used for different type of the condition of the target area. In the system of the present invention, this unit can connect directly or indirectly to, at least, a unit to notify a progress and/or a completion of the applicator action.

Optionally, this detecting step/unit or another step/unit can control the applicator to automatically change the action of the applicator depending on the condition of the target area. The method/system of the present invention optionally contain a step/unit to control the applicator to automatically change the action of the applicator depending on the condition of the target area. This control can be done based on a pre-determined applicator action, wherein the predetermined applicator action relates to one of more of type of action (such as vibration, heating/cooling, and/or emission of UV, laser, or infra-red), action duration, action intensity, alignment accuracy, speed of movement of applicator. In the system of the present invention, this unit can connect directly or indirectly to, at least, a unit to notify a progress and/or a completion of the applicator action.

FIG. 1I represents a step/unit of notifying a progress and/or a completion of the applicator action. Notification can be made by, for example, displaying and/or announcing, in more detail, at least one of the followings: visual display of the progress of the applicator action, visual display of the completion of applicator action; audio announcement of the progress of the applicator action, audio announcement of the completion of applicator action. Such visual displays can include, for example: color change of the graphic to point out the target area; dynamic motions such as star's flying out; quantified visual display such as change of number of stars and change in score bar.

In the present invention, preferred is a visual display of the progress and the completion of the applicator action in accordance with the color change of the graphic to point out the target area. For example, the intensity of the color of the graphic becomes lighter according to the progress of the applicator action, and then becomes transparent (disappeared) upon the completion of the applicator action. FIG. 2C shows that about a half of the colored graphic 170 on the target area 160 is disappeared in a middle of the applicator action, and FIG. 2D shows that the colored graphic 170 on the target area 160 is completely disappeared which notifies the completion of the applicator action.

FIG. 2A-2D show an example of the present invention where a user is directed how to use an applicator 150. FIG. 2A shows how an application surface 100, in this case, a user's face, and the target area 160 might be displayed on a mobile computing device, such as a mobile phone. FIG. 2B shows how the applicator 150 and the graphic 170 to point out the target area 160 may be displayed on the device in combination with the display of the application surface 100. FIGS. 2C and 2D show how the graphic 170 changes to display the progress and the completion of the applicator action.

As shown below, the unique combination of displaying the application surface 100, the target area 160, the applicator 150 and notifying the progress and/or a completion of the applicator action, to direct how the applicator should be used has been surprising found to provide not only significantly improved compliance with use instructions, but also improved efficacy of the applicator and improved overall satisfaction with the applicator.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for guiding users to use an applicator, the method including the steps of:
(a) detecting an application surface;
(b) detecting a target area in the application surface;
(c) creating a graphic to point out the target area;
(d) displaying the application surface and the graphic to point out the target area, to a user in real-time;
(e) detecting a location of the applicator;
(f) detecting an action of the applicator on the target area; and
(g) notifying a progress and/or a completion of the applicator action.

2. The method of claim 1, wherein the step of notifying the progress and/or the completion of the applicator action includes at least one of a visual display of the progress of the applicator action, a visual display of the completion of the applicator action, an audio announcement of the progress of the applicator action, and an audio announcement of the completion of the applicator action.

3. The method of claim 2, wherein the step of notifying the progress and/or the completion of the applicator action includes a visual display of the progress and the completion of the applicator action in accordance with a color change of the graphic to point out the target area.

4. The method of claim 1, wherein the step of creating the graphic contains a creation of one or more type of graphics wherein each of the one or more type of graphics are for one or more conditions of the target area.

5. The method of claim 1, further comprising a step of displaying a condition of the target area.

6. The method of claim 5, wherein the display of the condition of the target area includes at least one of an indication of a level of a certain condition and an indication of a type of condition.

7. The method of claim 1, further comprising controlling the applicator to automatically change the action of the applicator depending on a condition of the target area.

8. The method of claim 1, further comprising detecting pre-determined features on the application surface.

9. The method of claim 1, further comprising generating x, y and z coordinates of the application surface and/or pre-determined features.

10. The method of claim 1, wherein the steps are performed using a device selected from the group consisting of a computer, a mobile phone, and a mobile tablet computer.

11. A system for guiding a user to use an applicator, the system comprising:
(a) a unit to detect an application surface;
(b) a unit to detect a target area in the application surface;
(c) a unit to create a graphic to point out the target area;
(d) a unit to display the application surface and the graphic to point out the target area, to a user in real-time;
(e) a unit to detect a location of an applicator;
(f) a unit to detect the action of the applicator on the target area; and
(g) a unit to notify a progress and/or a completion of the applicator action, wherein each of the units in (a) to (f) are in electronic communication with at least one other unit in (a) to (f).

12. The system of claim 11, wherein the notification of the progress and/or the completion of the applicator action includes at least one of a visual display of the progress of the applicator action, a visual display of the completion of the applicator action, an audio announcement of the progress of the applicator action, and an audio announcement of the completion of applicator action.

13. The system of claim 12, wherein the notification of the progress and/or the completion of the applicator action includes a visual display of the progress and/or the completion of the applicator action in accordance with a color change of the graphic to point out the target area.

14. The system of claim 11, wherein the creation of the graphic contains a creation of one or more types of graphics, and wherein each of the one or more types of graphics are for one or more conditions of the target area.

15. The system of claim 11, further comprising a unit to display a condition of the target area.

16. The system of claim 15, wherein the display of the condition of the target area includes at least one of an indication of a level of a certain condition and an indication of a type of condition.

17. The system of claim 11, further comprising a unit to control the applicator to automatically change the action of the applicator depending on the condition of the target area.

18. The system of claim 11, additionally including a unit to detect pre-determined features on the application surface.

19. The system of claim 11, additionally including a unit to generate x, y and z coordinates of the application surface and/or pre-determined features.

20. The system of claim 14, wherein the steps are performed using a device selected from the group consisting of a computer, a mobile phone, and a mobile tablet computer.
